(19) United States
(12) Patent Application Publication
(10) Pub. No.: US 2023/0153166 A1
(43) Pub. Date: May 18, 2023

(54) SYSTEMS AND METHODS FOR PATTERN-BASED SOFTWARE APPLICATIONS

(71) Applicants: Aaron Bawcom, Atlanta, GA (US); Sebastian Becerra, Atlanta, GA (US); Beau Bennett, Atlanta, GA (US)

(72) Inventors: Aaron Bawcom, Atlanta, GA (US); Sebastian Becerra, Atlanta, GA (US); Beau Bennett, Atlanta, GA (US)

(21) Appl. No.: 17/529,501

(22) Filed: Nov. 18, 2021

(51) Int. Cl. G06F 9/50; G06F 8/60

(52) U.S. Cl. CPC G06F 9/5055; G06F 9/5072; G06F 8/60

(57) ABSTRACT

To deploy software resources in a cloud service according to an application pattern, a computing device implements an application pattern layer comprising one or more application patterns for one or more types of software resources deployed in a cloud service. Each application pattern includes a set of operating parameters defining aspects of a cloud computing environment. The computing device obtains a particular software resource for deployment in the cloud service, assigns the particular software resource to a particular one of the one or more application patterns, and runs the particular software resource within the particular application pattern in the cloud service.

### FIELD OF THE DISCLOSURE

The present disclosure relates to cloud-based computing applications and more particularly to defining application patterns for improving development and deployment of such applications in the cloud.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The adoption of cloud computing has accelerated in recent years, with large and small organizations taking advantage of the scalability, low initial costs, security, and reliability offered by cloud service providers. Cloud service providers offer cloud computing resources to customers, including cloud platform services and cloud infrastructure services upon which customers can deploy and run software applications. With the expansion of cloud-based storage and processing, many applications and services have been developed for or migrated to the cloud. This has resulted in a proliferation of cloud-based applications, each needing separate configuration and management for its particular use. Such individualization is time-consuming for application developers and limits interoperability between applications and across platforms. With each cloud service provider using its own protocols, applications developed for one cloud service provider's requirements may not work with other cloud services. Additionally, such individualization of each platform and application reduces security by introducing additional attack points. Beyond initial development and configuration, maintaining and managing cloud software applications across numerous platforms, cloud environments, locations, and business units increases the number of opportunities for errors, incompatibilities, and attacks.

Previous attempts to address the issues have been inadequate and have only succeeded in reducing the impact of these problems by significantly limiting the functionality and flexibility of cloud-based applications. For example, application blueprints have been used to restrict cloud-based applications to limited functions for specific fields of use, thus avoiding issues of complexity and interoperability by defining a limited scope for a class of applications. However, such approach effectively locks the applications into a rigid set of allowed operations that serve a specific type of uses, thus requiring new blueprints for each new use case or functionality. Such solutions thus fail to obtain many of the advantages of cloud computing by sacrificing flexibility and functionality for simplicity. Improved cloud computing architecture and techniques are needed.

Additionally, because of the volume of software resources being migrated to the cloud, there is a corresponding effort to provide tools to assist teams involved in cloud migration. However, the scale and complexity of these migrations creates a considerable challenge for most enterprises. Further, current approaches and tools used for cloud-migration by DevOps teams and others are often cumbersome and inefficient for many users. As a result, even though cloud solutions such as Amazon Web Services (AWS) go to tremendous lengths to help enterprises transition to the cloud, the process can be unsuccessful. In fact, close to sixty percent of enterprises report stalled or failed cloud migrations. Accordingly, improvements in the software tools and processes used for cloud migration are needed.

Properly securing IT assets that run in cloud infrastructure is one of the largest reasons for stalled cloud deployments. There are several Infrastructure-as-Code (IaC) technologies that declaratively describe infrastructure including but not limited to YAML or HCL based configurations. There have been attempts to provide static pre-deployment analysis of IaC for security purposes using Policy as Code (PaC) based technologies. However, some of these approaches do not provide the level of abstractions needed to allow a user to specify many of the diverse forms of security specifications that can be used to secure infrastructure resources.

An enterprise-wide migration to the public cloud may involve thousands of workloads. As a result, the selection and prioritization of multiple software applications for migration to the cloud is a fundamental challenge faced by enterprises. Tools that provision and manage infrastructure allow an enterprise to specify the entire rollout of multiple applications on the cloud using “Infrastructure-as-Code” (IaC). Today, with IaC, the infrastructure details are specified in a language and the code instructions defined in that language are then run by a tool. With the entire infrastructure and operational characteristics of an application stored as code in a source code repository, versioning, tracking and managing the infrastructure can be achieved with greater accuracy using fewer resources. However, current approaches require extensive training and experience to generate IaC. As a result, engineers must manually write the code instructions to specify the details of the infrastructure before the software resources are deployed to the cloud. Further, it is difficult to find engineers with the required skills.

### SUMMARY

The present invention solves problems relating to the development, deployment, and management of cloud computing environments and cloud-based applications. To provide both flexibility and consistency across cloud-based systems, the techniques disclosed herein provide a pattern-based cloud computing architecture that combines a base layer, a landing zone layer, and an application pattern layer. The disclosure herein generally relates to systems, methods, and non-transitory computer-readable media storing instructions for providing such a cloud-based architecture facilitating deployment of cloud-based software applications. The systems, methods, and instructions disclosed herein may be implemented by cloud servers, client computing devices connected to cloud servers, enterprise computing devices connected to a local network, or combinations thereof.

In particular, an example embodiment of the techniques of the present disclosure is a method for deploying software resources in a cloud service according to an application pattern. The method includes implementing an application pattern layer comprising one or more application patterns for one or more types of software resources deployed in a cloud service. Each application pattern includes a set of operating parameters defining aspects of a cloud computing environment. The method further includes obtaining a particular software resource for deployment in the cloud service, assigning the particular software resource to a particular one of the one or more application patterns, and running the particular software resource within the particular application pattern in the cloud service.

Another embodiment of these techniques is a computing device for deploying software resources in a cloud service according to an application pattern. The computing device includes one or more processors and a non-transitory computer-readable medium storing instructions thereon. When executed by the one or more processors, the instructions cause the computing device to implement an application pattern layer comprising one or more application patterns for one or more types of software resources deployed in a cloud service. Each application pattern including a set of operating parameters defining aspects of a cloud computing environment. The instructions further cause the computing device to obtain a particular software resource for deployment in the cloud service, assign the particular software resource to a particular one of the one or more application patterns, and run the particular software resource within the particular application pattern in the cloud service.

Yet another embodiment of these techniques is a non-transitory computer-readable memory coupled to the one or more processors and storing instructions thereon. When executed by the one or more processors, the instructions cause the one or more processors to implement an application pattern layer comprising one or more application patterns for one or more types of software resources deployed in a cloud service. Each application pattern including a set of operating parameters defining aspects of a cloud computing environment. The instructions further cause the one or more processors to obtain a particular software resource for deployment in the cloud service, assign the particular software resource to a particular one of the one or more application patterns, and run the particular software resource within the particular application pattern in the cloud service.

### BRIEF DESCRIPTION OF THE DRAWINGS

FIG. 1 illustrates a block diagram of an exemplary pattern-based cloud architecture showing layer hierarchy.

FIG. 2 illustrates a block diagram of an exemplary pattern-based cloud system showing isolation of software resources using the pattern-based cloud architecture.

FIG. 3 illustrates a block diagram of an exemplary cloud computing system showing hardware components and communication connections.

FIG. 4 illustrates a detailed block diagram similar to the block diagram of the exemplary pattern-based cloud architecture of FIG. 1.

FIG. 5 illustrates an example data table defining the set of operating parameters for application patterns in the exemplary pattern-based cloud architecture of FIG. 1.

FIGS. 6A-6J illustrate example sets of operating parameters and corresponding operating parameter values for different application patterns.

FIG. 7 illustrates a flow diagram of an exemplary method for deploying software resources in a cloud service according to an application pattern according to certain embodiments.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this disclosure is referred to in this disclosure in a manner consistent with a single meaning, that is done for the sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

As used herein, the term “cloud computing” refers to a model for enabling ubiquitous, convenient, on-demand network access to a shared pool of configurable computing resources (e.g., networks, servers, storage, applications, and services) that can be rapidly provisioned and released with minimal management effort or service provider interaction.

As used herein, the term “infrastructure-as-code” refers to management of infrastructure (networks, virtual machines, load balancers, and connection topology) in a descriptive model, using the same versioning tools as software development teams use for source code.

The systems, methods, and techniques described herein solve various problems relating to security, compatibility, flexibility, and reusability in the design, development, deployment, and management of cloud computing environments and cloud-based software applications. To obtain the benefits of consistency across environments as well as the benefits of flexible design, the techniques disclosed herein describe a pattern-based cloud architecture that may be implemented in conjunction with pattern-based cloud software applications. Unlike existing techniques, the pattern-based cloud architecture provides a plurality of application patterns comprising cloud computing environments that are defined by a combination of application services and/or operating parameters. The pattern-based cloud architecture also provides a plurality of landing zones comprising cloud computing environments that are defined by a combination of landing zone services and/or operating parameters inherited from the landing zone with which each application pattern is associated. Furthermore, the pattern-based cloud architecture includes base services and/or operating parameters inherited from the base with which each landing zone is associated. Additional, fewer, or alternative aspects may be included in various embodiments, as described herein.

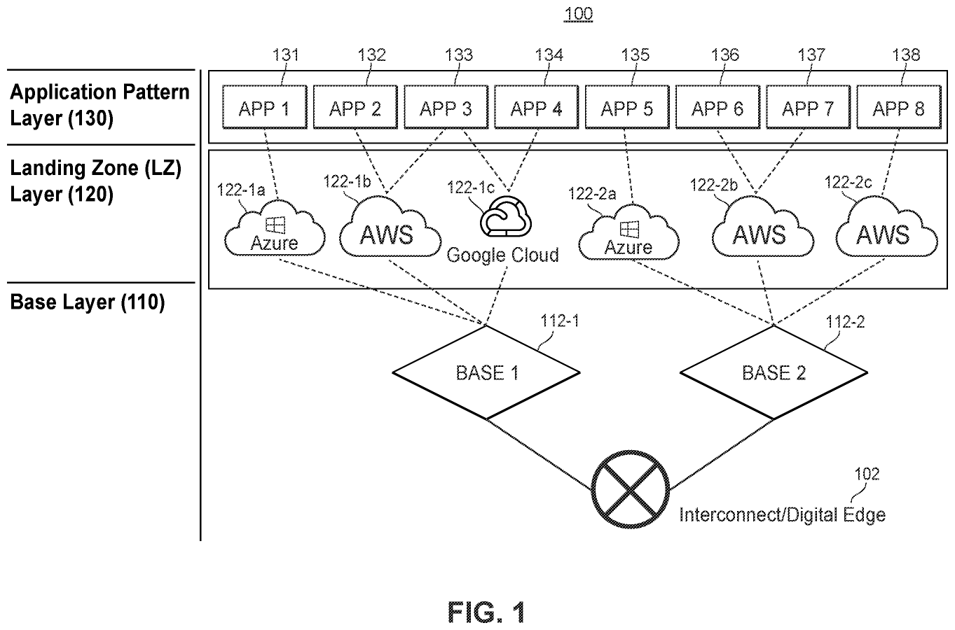

FIG. 1 illustrates a block diagram of an exemplary pattern-based cloud architecture 100 layer hierarchy for deploying a multi-layer cloud infrastructure. The example architecture 100 may be implemented across multiple networks at multiple locations (e.g., commercial cloud service providers, private clouds, or local area networks), while maintaining both separation of individual components and common configuration among related components within the architecture. A plurality of pattern-based applications may be deployed as cloud-based software applications configured to run in cloud computing environments. Such pattern-based applications run within corresponding application patterns 131-138 of the application pattern layer 130 to provide data management and analysis functionality or perform other operations by running within corresponding cloud environments defined by the corresponding landing zones 122 of the landing zone layer 120. The landing zones 122 define constraints and capabilities available to the applications according to the application patterns 131-138 by defining the operating environment for the execution of application instructions. Each of the landing zones 122 is defined in part by a corresponding base 112 of the base layer 110, which also provides certain base services and defines constraints for all the landing zones 122 based thereupon. The landing zones 112 further provide connectivity to the interconnect 102 (or digital edge) of the pattern-based cloud architecture 100, thereby providing access to other network assets (e.g., computing devices, data repositories, data streams, or other data sources or data consumers).

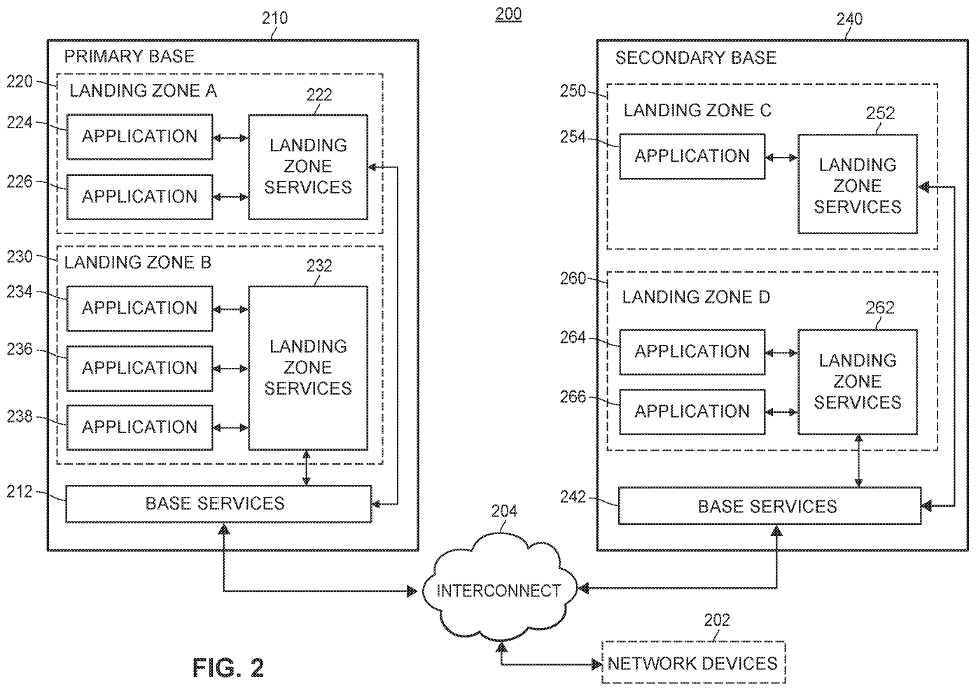

As illustrated in the example embodiment of FIG. 1, the pattern-based cloud architecture 100 comprises two bases 112 in the base layer 110. The first base 112-1 supports landing zones 122-1a, 122-1b, and 122-1c with a first set of operating parameters and base services, while the second base 112-2 supports landing zones 122-2a, 122-2b, and 122-2c with a second set of operating parameters and base services. As discussed further herein, the operating parameters partially define the functional or service level requirements of the cloud environments implemented as the corresponding landing zones 122. Similarly, the base services provide network connection and other common services to the landing zones 122 and, through them, the pattern-based applications. Each of the bases 112 thus provides fundamental services and defines common constraints for all the corresponding cloud computing environments that are associated with such base 112. The application pattern layer 130 comprises a plurality of application patterns 131-138 defining operating parameters for running pattern-based cloud applications associated with the respective landing zones. The application patterns 131-138 may be implemented using several different technologies/services, such as IaC, PaC, Security-as-Code (SaC), Threat-Modeling-as-Code (TMaC), Pipeline-as-Code (PiaC), etc. Such pattern-based applications are each configured to run within or access a corresponding application pattern 131-138 within one or more of the landing zones 122. The pattern-based applications are illustrated below in FIG. 2.

As illustrated in FIG. 1, the application patterns 131-138 may include a first application pattern 131 associated with landing zone 122-1a, a second application pattern 132 associated with landing zone 122-1b, a third application pattern 133 associated with landing zones 122-1b and 122-1c, a fourth application pattern 134 associated with landing zone 122-1c, a fifth application pattern 135 associated with landing zone 122-2a, a sixth application pattern 136 associated with landing zone 122-2b, a seventh application pattern 137 associated with landing zone 122-2b, and an eighth application pattern 138 associated with landing zone 122-2c. Thus, more than one application pattern may be associated with a landing zone. Additionally, some application patterns may be associated with more than one of the landing zones, such as the third application pattern 133, which is associated with landing zones 122-1b and 122-1c. An application pattern 131-138 may be assigned to a landing zone 122 based on the application pattern 131-138 and landing zone 122 having the same or similar constraints, such as the same or similar decision rights, resiliencies, security classifications, and/or engagement models. Although eight application patterns 131-138 are shown, the architecture described herein facilitates the addition, removal, and reconfiguration of any number of application patterns.

This produces several advantages, including standardization of the cloud computing environments (and thus of the applications running therein), efficiency in updating or reconfiguring multiple cloud computing environments (i.e., multiple landing zones 122) through changes to the corresponding base 112, isolation of cloud resources (e.g., by data type, software suite, or business unit), and integration of legacy applications with new applications within a common infrastructure. Moreover, the application patterns 131-138 utilize several different technologies (e.g., IaC, SaC, PaC, TMaC, PiaC, etc.) in a single package. This is advantageous over alternative systems which may require a cloud developer to utilize these technologies separately when deploying an application in a cloud computing environment. Although two bases 112 are illustrated in the base layer 110, the architecture described herein facilitates the addition, removal, and reconfiguration of any number of bases, thereby further improving the flexibility of the overall cloud-based system.

As further illustrated in the example embodiment, each of the six landing zones 122 is associated with one and only one of the bases 112, thereby inheriting the operating parameters and base services of the respective base 112. Thus, each of landing zones 122-1a, 122-1b, and 122-1c inherits part of its services and constraints from the first base 112-1, while each of landing zones 122-2a, 122-2b, and 122-2c inherits part of its services and constraints from the second base 112-2. Nonetheless, each landing zone 122 remains separate from each other landing zone 122, thereby isolating the data and operations within each of the landing zones 122. Accordingly, the landing zones 122 may be implemented as cloud computing environments by different cloud computing platforms (e.g., private or commercial cloud service providers using various protocols). For example, landing zones 122-1a and 122-2a may be Azure Web Apps cloud computing environments by Microsoft Corporation, while landing zones 122-1b, 122-2b, and 122-2c may be Amazon Web Services cloud computing environments by Amazon.com, Inc., and landing zone 122-1c may be a Google Cloud Platform cloud computing environment by Google LLC. Thus, each of the landing zones 122-1a, 122-1b, and 122-1c is a separate type of cloud environment (i.e., cloud computing environments provided by different cloud service providers having different protocols and/or features). The features or characteristics of the landing zones 122 associated with a particular base 112 may also differ, within the limits of the constraints imposed by the base 112. Thus, landing zone 122-2a is a different type of cloud environment, while landing zones 122-2b and 122-2c are cloud environments of the same type but differ in their characteristics. For example, landing zones 122-2b and 122-2c may be implemented by the same cloud service provider using the same protocols, but they may differ with respect to parameters, capabilities, access, restrictions, or features.

Moreover, each of the application parameters 131-138 inherits the operating parameters and cloud computing environment of the respective landing zone 122. Thus, application pattern 131 inherits part of its operating parameters and cloud computing environment from landing zone 122-1a, application pattern 132 inherits part of its operating parameters and cloud computing environment from landing zone 122-1b, application pattern 133 inherits part of its operating parameters and cloud computing environment from either landing zone 122-1b or landing zone 122-1c, application pattern 134 inherits part of its operating parameters and cloud computing environment from landing zone 122-1c, application pattern 135 inherits part of its operating parameters and cloud computing environment from landing zone 122-2a, application patterns 136 and 137 inherit part of their operating parameters and cloud computing environment from landing zone 122-2b, and application pattern 136 inherits part of its operating parameters and cloud computing environment from landing zone 122-2c.

The features or characteristics of the application patterns 131-138 associated with particular landing zone(s) 122 may also differ, within the limits of the constraints imposed by the landing zone(s) 122. Thus, application patterns 132 and 133 may be for different types of software resources (e.g., reports, approval workflows, Internet of Things (IoT) device services, web applications, containers, container clusters, 3-tier web applications, extract, transform, and load (ETL) transformations, extract, load, and transform (ELT) transformations, virtual machines, user desktops, websites, databases, data warehouses, streaming services, batch services, or application programming interfaces (APIs)). For example, application pattern 132 may be for containers within landing zone 122-1b while application pattern 133 may be for virtual machines within landing zone 122-1b. Additionally, application patterns 132 and 133 may be for different operating systems (e.g., Windows and Linux).

This structured flexibility of the base layer 110, the landing zone layer 120, and the application pattern layer 130 produces further advantages, including improving efficiency of deploying and managing cloud environments through standardization of a subset of their characteristics through corresponding bases, enhancing stability and security through isolating separate instances of cloud environments having characteristics applicable to all applications running therein, and facilitating the development and deployment of pattern-based cloud applications that limit the variability of each application and reduce the time required for configuration or reconfiguration of each such application. Although eight application patterns 131-138 are illustrated as being associated with each of the three landing zones 122 which are illustrated as being associated with each of the two bases 112, the architecture described herein facilitates the addition, removal, and reconfiguration of any number of application patterns for any number of landing zones, and any number of landing zones for any number of bases, thereby further improving the flexibility of the overall cloud-based system.

Each application pattern 131-138 defines a set of operating parameters for implementing the pattern-based applications within the landing zone(s) 122. The pattern-based applications may be cloud-native applications running in cloud environments implemented in the application patterns 131-138 and the landing zones 122. In some embodiments, the pattern-based applications may be other software applications configured to communicate with cloud-based services for obtaining or processing data (e.g., software applications running on local computing hardware communicating with cloud-based applications or services running within the landing zones via external application programming interfaces (APIs)).

Each pattern-based application is configured to assume certain services and operating parameters will be provided by the application pattern 131-138 and/or landing zone 122 associated with such application, part of which services and operating parameters will be inherited by the landing zone 122 from the corresponding base 112. Since the operating parameters and services of each pattern-based application must match those of its one or more associated landing zones 122, each such application is developed according to an application pattern 131-138 defining the types of landing zones with which it is compatible. This pattern matching enables the pattern-based applications to be developed in an efficient manner, while allowing flexibility of specific operating parameters and services through the association of pattern-based applications with specific landing zones 122 and their corresponding bases 112.

In some instances, a single cloud-based software application may be developed once but deployed multiple times, with different instances being associated with different landing zones 122 in order to specify operating parameters (including data sources) through association with the application patterns 131-138 and/or landing zones 122. For example, the third application pattern 133 is associated with both landing zone 122-1b and landing zone 122-1c, thus allowing pattern-based applications implemented with the operating parameters of the third application pattern 133 to be associated with (e.g., deployed within) either landing zone 122-1b or landing zone 122-1c.

Also in some instances, multiple application patterns may be associated with the same landing zone. For example, the third application pattern 133 and the fourth application pattern 134 are associated with landing zone 122-1c. The third application pattern 133 may be for pattern-based applications associated with landing zone 122-1c having a first software resource type (e.g., virtual machines), while the fourth application pattern 134 may be for pattern-based applications associated with landing zone 122-1c having a second software resource type (e.g., streaming services).

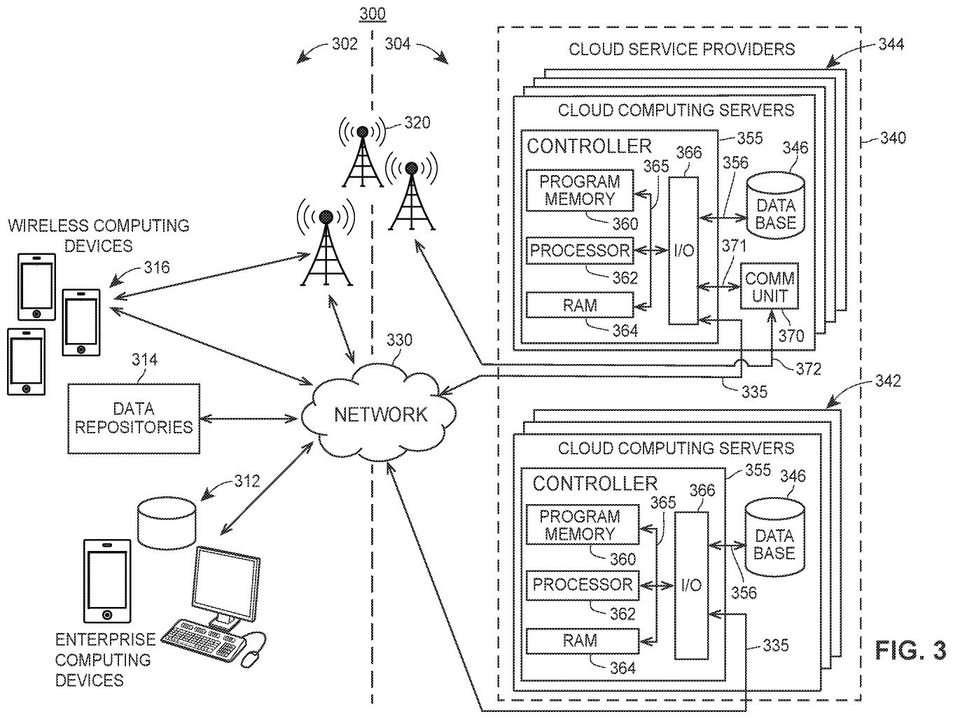

FIG. 2 illustrates a block diagram of an exemplary pattern-based cloud system 200 showing isolation of software components using the pattern-based cloud architecture described herein. As will be apparent, the example system 200 illustrates an alternative view and an alternative configuration of such pattern-based cloud architecture in order to emphasize the features and flexibility of such architecture. The example system 200 comprises software components implemented by hardware components, such as those described below with respect to FIG. 3. As shown, a primary base 210 and a secondary base 240 are connected via an interconnect 204 to network devices 202, which may provide data to and/or receive data from the primary and secondary bases 210 and 240. Such network devices 202 may thus include data repositories or data streams, as well as software applications running on hardware devices configured to communicate data via the interconnect 204 with the various cloud-based applications associated with the primary and secondary bases 210 and 240.

Each of the primary base 210 and the secondary base 240 comprises a plurality of landing zones, each of which is further associated with one or more cloud-based applications. Although both the primary base 210 and the secondary base 240 are connected via the interconnect 204 with the network devices 202, each of the bases may be configured to connect to a subset of the total network devices 202. In some such embodiments, the subsets may be partially or fully overlapping, such that some network devices 202 are connected to communicate with both bases 210 and 240. For example, the primary base 210 may be associated with a legacy system architecture corresponding to a first plurality of network assets of the network devices 202, while the secondary base 240 may be associated with an additional system architecture corresponding to a second plurality of network assets of the network devices 202. In such example, the legacy system architecture may be integrated with the additional system architecture into a common pattern-based cloud architecture without loss of data quality and without significant alteration to the legacy system.

As illustrated, each of the bases provides software services to all of its landing zones, while each of the landing zones further provides additional software services to any applications running within or accessing the landing zone. Thus, primary base 210 includes a plurality of base services 212, which are available to landing zone A 220 and landing zone B 230. The secondary base 240 likewise includes another plurality of base services 242, which are available to landing zone C 250 and landing zone D 260. The base services 212 and 242 may both include an identical set of services, or the base services 212 may differ in number, type, or configuration from the base services 242. Each of the bases 210 and 240 provides at least base services implementing network communication via the interconnect 204, thereby connecting to the network devices 202. Along with such communication services, other fundamental services for deploying, configuring, or managing landing zones 220, 230, 250, 260 may be included in the base services 212 and 242. Additionally, the base services 212 and 242 may further include any common services expected to be of use to all or most landing zones 220, 230, 250, 260. Without limitation, such common services may include services relating to monitoring landing zone performance, logging application operations, providing data security, performing load balancing, managing software licenses, and/or providing resiliency for data and applications. In some embodiments, further services useful for particular data sets or cloud environments may be included in the base services 212 or 242 in order to ensure consistency in the services available across the applications of all the landing zones 220 and 230 of primary base 210 or landing zones 250 and 260 of the secondary base 240, respectively.

In addition to base services 212 and 242, the exemplary pattern-based cloud system 200 includes services specifically implemented for each landing zone. Thus, each landing zone 220, 230, 250, 260 has zone-specific services and services common to all landing zones in the same base. For example, landing zone A 220 provides the base services 212 and landing zone services 222 in order to support applications 224 and 226. Similarly, landing zone B provides the base services 212 and landing zone services 232 to applications 234, 236, 238. Thus, both landing zones A and B provide the same base services 212, in addition to providing different landing zone-specific services. The landing zones C and D of the secondary base 240 function similarly. Landing zone C 250 provides the base services 242 and landing zone services 252 in order to support application 254, and landing zone D 260 provides the base services 242 and landing zone services 262 in order to support applications 264 and 266.

The landing zone services expand upon the base services to provide additional functionality within the respective landing zones, thereby providing further standardization to the applications associated therewith. As illustrated, the base services 212 may be accessed by or incorporated into the landing zone services 222 and 232, and the base services 242 may be accessed by or included in the landing zone services 252 and 262. The landing zone services 222, 232, 252, 262 may include services relating to security, compliance, monitoring and logging, data access and storage, application management, virtualization or container management, or other functions of the corresponding cloud environments. As each landing zone 220, 230, 250, 260 implements a specifically configured cloud computing environment capable of supporting the various cloud-based applications associated therewith, the corresponding landing zone services 222, 232, 252, 262 may include any services necessary to fully implement such cloud environments in connection with any base services 212 or 242. In some embodiments, some or all of the landing zone services may include one or more services that are made available by the corresponding landing zones to applications running within or accessing such landing zones, as well as services performing necessary functions to run, secure, and monitor the landing zones.

In order to isolate each of the various landing zones 220, 230, 250, 260 from the other landing zones, the base services 212 and 242 may further implement virtual network services to establish separate virtual networks with each landing zone within the corresponding bases in some embodiments. For example, the base services 212 may establish a first virtual private network for communication with landing zone A 220 and a second virtual private network for communication with landing zone B 230. In further embodiments, the base services 212 and 242 may additionally or alternatively establish virtual network connections with network devices 202 via the interconnect 204. In some embodiments, the base services 212 and 242 may establish virtual networks through the respective landing zones to specific applications 224, 226, 234, 236, 238, 254, 264, 266. In further embodiments, the landing zones 220, 230, 250, 260 may establish separate virtual network connections with for their respective applications in order to provide further separation of the applications within each landing zone. The implementation of such virtual networks improves security and control of the landing zones and applications, but such virtual networks are not required and may be omitted from some embodiments for convenience.

In addition to services, each of the bases and landing zones is configured according to operating parameters specifying environmental parameters or other variable constrains in order to configure the landing zones 220, 230, 250, 260 as cloud computing environments by establishing functional or non-functional requirements and limitations of such environments. The operating parameters may thus define performance of the landing zones as cloud computing environments in running cloud-based software applications (e.g., the performance of landing zone A in running applications 224 and 226 as cloud-based applications within a virtual machine or an operating system of a cloud environment). Performance of the cloud computing environments may be considered in terms of functionality, resource availability, security, compliance, quality of service, or other aspects affecting the operation of the environments. In some embodiments, the operating parameters of a landing zone may include policies comprising rules to be enforced by the respective landing zone for all software applications running in such cloud computing environment, which rules may be related to one or more of the following: security, compliance, authentication, authorization, or data access.

The operating parameters may be partially defined by the bases 210 and 240, along with the base services 212 and 242. Additional landing zone-specific operating parameters may be further defined for each of the landing zones 220, 230, 250, 260, along with the respective landing zone services 222, 232, 252, 262. Such operating parameters may be set when each base or landing zone is initially deployed and may be updated at any time to adjust operation of the respective landing zones. In some embodiments, the operating parameters may be imported from infrastructure libraries of previously selected sets of operating parameters and services, which may be reused and combined in various combinations across different bases or landing zones. Such infrastructure libraries may also include services that may be incorporated into the base services or landing zone services when designing various bases and landing zones. The use of such infrastructure libraries thus improves consistency and reduces development time, while promoting flexibility in the combinations of operating parameters and services included in the various infrastructure library files.

As an example of the use of such a pattern-based cloud architecture 100 implemented by a system such as the pattern-based cloud system 200, enterprise logging, monitoring, and analytics (ELMA) functions may be implemented in an integrated manner using a pattern-based cloud architecture. Using current ELMA techniques, both the volume of data generated in cloud environments and the complexity of logs generated across disparate cloud environments limit the effectiveness of such log data for identifying and addressing security or performance issues across complex enterprise systems. The availability of data is improved by handling data ingestion separately in each of the various landing zones 220, 230, 250, 260, while using a common basis for each broader group of cloud environments and applications through the associated bases 210 and 240. Consistent data from cloud environments using different cloud service providers is thus logged in the landing zones 220, 230, 250, 260 and filtered in a useable form through the corresponding bases 210 and 240 to the interconnect 204. From there, such data may be analyzed at the network devices 202, and appropriate corrective measures may be implemented as needed. When corrective measures are required, the pattern-based cloud architecture further facilitates such adjustments by allowing changes at the bases 210 and 240 (e.g., updates to base services or operating parameters) that will apply to all their respective landing zones and applications, as well as changes to the landing zones 220, 230, 250, 260 (e.g., updates to landing zone services or operating parameters) that will apply to specific landing zones. Additionally, changes to pattern-based applications may be made to groups of cloud-based applications based upon their pattern types. In some situations, this may allow issues to be fixed for all cloud-based applications having the same type of pattern based upon data indicating problems in only some of such applications, even before the issues appear in other such applications of the same pattern type.

FIG. 3 illustrates a block diagram of an exemplary cloud computing system 300 showing hardware components and communication connections. The various components of the cloud computing system 300 are communicatively connected and configured to support the pattern-based architecture and to implement the methods described further herein. The high-level architecture may include both hardware and software applications, as well as various data communications channels for communicating data between the various hardware and software components. The cloud computing system 300 may be roughly divided into front-end components 302 and back-end components 304. The front-end components 302 may be associated with users, developers, administrators, data sources, and data consumers. The back-end components 304 may be associated with public or private cloud service providers, including departments responsible for enterprise data infrastructure.

The front-end components 302 may include a plurality of computing devices configured to communicate with the back-end components 304 via a network 330. Various computing devices (including enterprise computing devices 312, data repositories 314, or wireless computing devices 316) of the front-end components 302 may communicate with the back-end components 304 via the network 330 to set up and maintain cloud computing environments, install and run cloud-based applications, provide data to such applications, and receive data from such applications. Each such computing device may include a processor and program memory storing instructions to enable the computing device to interact with the back-end components 304 via the network 330, which may include special-purpose software (e.g., custom applications) or general-purpose software (e.g., operating systems or web browser programs). As illustrated, the wireless computing devices 316 may communicate with the back-end components 304 via a cellular network 320, such as a 5G telecommunications network or a proprietary wireless communication network. The computing devices may also include user interfaces to enable a user to interact with the computing devices.

The physical hardware of the front-end components 302 may provide a plurality of software functionalities. Thus, the front-end components 302 may include a plurality of automatic data sources that provide data to the back-end components 304, such as streaming data sources, Internet of Things (IoT) devices, or periodically updating databases configured to push data to one or more cloud-based applications. Additionally or alternatively, the front-end components 302 may include a plurality of accessible data sources that provide data to the cloud-based applications upon request, such as databases, client applications, or user interfaces. Other front-end components 302 may further provide developer or administrator access to the cloud computing assets of the back-end components 304.

The back-end components 304 may comprise a plurality of servers associated with one or more cloud service providers 340 to provide cloud services via the network 330. A first plurality of cloud computing servers 342 may be associated with a first cloud service provider, while a second plurality of cloud computing servers 344 may be associated with a second cloud service provider. Additionally or alternatively, the cloud computing servers 342 and 344 may be distributed across a plurality of sites for improved reliability and reduced latency. The cloud computing servers 342 and 344 may collectively implement various aspects of the methods described herein relating to the pattern-based cloud architecture. As illustrated, the cloud computing servers 342 and 344 may communicate with the front-end components 302 via links 335 to the network 330, and the cloud computing servers 344 may further communicate with the front-end components 302 via links 372 to the cellular network 320. Additionally, the cloud computing servers 342 may communicate with cloud computing servers 344 via the network 330. Individual servers or groups of servers of either the cloud computing servers 342 or the cloud computing servers 344 may further communicate with other individual servers or groups of servers of the same respective cloud computing servers 342 or cloud computing servers 344 may also communicate via the network 330 (e.g., regional server groups of the same cloud service provider located at multiple sites may communicate with each other via the network 330).

Each cloud computing server 342 or 344 includes one or more processors 362 adapted and configured to execute various software stored in one or more program memories 360 to provide cloud services, such as hypervisor software, operating system software, application software, and associated routines and services. The cloud computing servers 342 and 344 may further include databases 346, which may be local databases stored in memory of a particular server or network databases stored in network-connected memory (e.g., in a storage area network). Each cloud computing server 342 or 344 has a controller 355 that is operatively connected to the database 346 via a link 356 (e.g., a local bus or a local area network connection). It should be noted that, while not shown, additional databases may be linked to the controller 355 in a known manner. For example, separate databases may be used for various types of information, for separate cloud service customers in a public cloud, or for data backup.

Each controller 355 includes a program memory 360, a processor 362 (which may be called a microcontroller or a microprocessor), a random-access memory (RAM) 364, and an input/output (I/O) circuit 366, all of which may be interconnected via an address/data bus 365. It should be appreciated that although only one processor 362 is shown for each controller 355, the controller 355 may include multiple processors 362. Similarly, the memory of the controller 355 may include multiple RAMs 364 and multiple program memories 360. Although the I/O circuit 366 is shown as a single block, it should be appreciated that the I/O circuit 366 may include a number of different types of I/O circuits. The RAM 364 and program memories 360 may be implemented as semiconductor memories, magnetically readable memories, or optically readable memories, for example. The controller 355 may also be operatively connected to the network 330 via a link 335.

Some cloud computing servers 344 may be communicatively connected to the cellular network 320 via a communication unit 370 configured to establish, maintain, and communicate through the cellular network 320. The communication unit 370 may be operatively connected to the I/O circuit 366 via a link 371 and may further be communicatively connected to the cellular network 320 via a link 372. In some embodiments, some cloud computing servers 344 may be communicatively connected to the cellular network 320 through the network 330 via the link 335.

The cloud computing servers 342 and 344 further include software stored in their program memories 360. The software stored on and executed by cloud computing servers 342 and 344 performs functions relating to establishing and managing virtual environments, such as managing resources and operation of various cloud computing environments (e.g., virtual machines running operating systems and other software for cloud service customers) in accordance with the pattern-based cloud architecture described herein. Additionally, the software stored on and executed by cloud computing servers 342 and 344 may further include cloud-based applications running in such cloud computing environments, such as pattern-based software applications making use of the pattern-based cloud architecture. Further software may be stored at and executed by controllers 355 of cloud computing servers 342 and 344 in various embodiments.

The various computing devices (e.g., enterprise computing devices 312, data repositories 314, or wireless computing devices 316) of the front-end components 302 communicate with the back-end components 304 via wired or wireless connections of the network 330 and/or via the cellular network 320. The network 330 may be a proprietary network, a secure public internet, a virtual private network or some other type of network, such as dedicated access lines, plain ordinary telephone lines, satellite links, cellular data networks, or combinations of these. The network 330 may include one or more radio frequency communication links, such as wireless communication links with front-end components 302. The network 330 may also include other wired or wireless communication links with other computing devices or systems. Where the network 330 may include the Internet, and data communications may take place over the network 330 via an Internet communication protocol.

Although the cloud computing system 300 is shown to include one or a limited number of the various front-end components 302 and of the back-end components 304, it should be understood that different numbers of any or each of these components may be utilized in various embodiments.

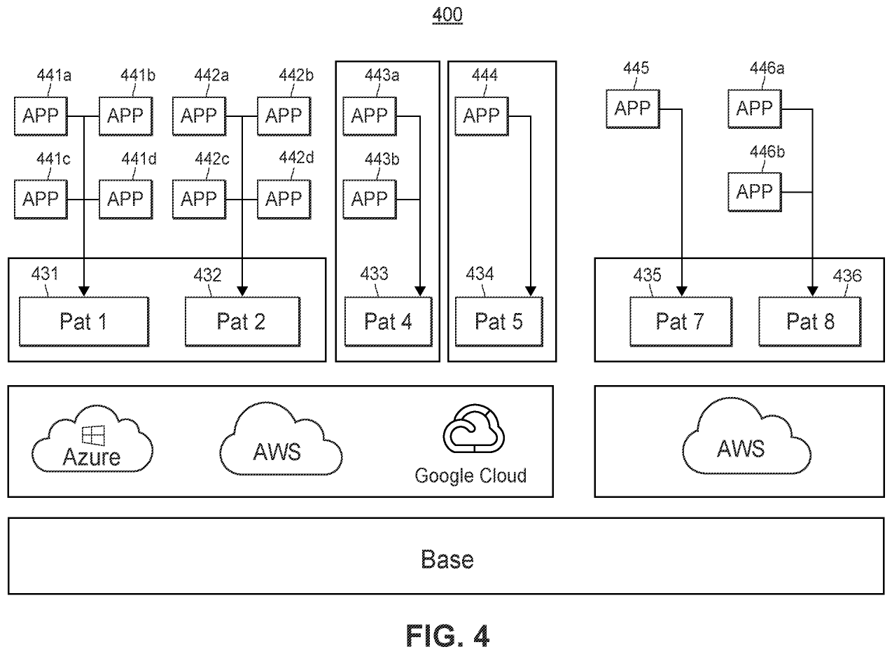

FIG. 4 illustrates a detailed block diagram 400 of the application pattern layer 130 of FIG. 1. Similar to FIG. 1, the block diagram 400 includes a base layer 410, a landing zones layer 420, and an application pattern layer 430. The block diagram 400 also includes pattern-based applications 441a-446b that are implemented within corresponding application pattern 431-436. For example, the application patterns include Pat 1 (ref. no. 431), Pat 2 (ref. no. 432), Pat 4 (ref. no. 433), Pat 5 (ref. no. 434), Pat 7 (ref. no. 435), and Pat 8 (ref. no. 438). Each application pattern 431-436 is assigned to a landing zone (e.g., by the enterprise computing device), such that the pattern-based applications 441a-441d assigned the application pattern 431 are configured to run within or access the assigned landing zone. In some implementations, an application pattern may be assigned to more than one landing zone or multiple application patterns may be assigned to the same landing zone. A pattern-based application 441a-441d may be assigned an application pattern 431-436 that is assigned the same landing zone as the pattern-based application 441a-441d. For example, when two application patterns are assigned to a particular landing zone and a pattern-based application is also assigned to the particular landing zone, then the pattern-based application may be assigned one of the two application patterns. The enterprise computing device 312, for example, may select which of the two application patterns to assign to the pattern-based application based on the software resource types of the two application patterns and the type of pattern-based application and/or based on the operating systems of the two application patterns and the operating system for the pattern-based application. The enterprise computing device 312 may select the application pattern having a matching software resource type and/or operating system to the pattern-based application. The software resource types may include virtual machines, containers, websites, databases, data warehouses, streaming services, batch services, application programming interfaces (APIs), etc.

Each application pattern 431-436 includes a set of operating parameters for running the pattern-based applications 441a-446b assigned to the application pattern 431-446. For example, applications 441a-441d are assigned to Pat 1 (ref. no. 431), applications 442a-442d are assigned to Pat 2 (ref. no. 432), applications 443a-443b are assigned to Pat 4 (ref. no. 433), application 444 is assigned to Pat 5 (ref. no. 434), application 445 is assigned to Pat 7 (ref. no. 435), and applications 446a-446b are assigned to Pat 8 (ref. no. 438). In addition to pattern-based applications, other software resources may be assigned application patterns in the cloud computing environment, such as virtual machines, containers, websites, databases, data warehouses, streaming services, batch services, or APIs. Each application pattern 431-436 may be generated for a particular type of software resource. For example, Pat 1 (ref. no. 431) may be the application pattern for virtual machines, Pat 2 (ref. no. 432) may be the application pattern for containers, Pat 4 (ref. no. 433) may be the application pattern for databases, etc. The enterprise computing device 312 may then assign software resources 441a-446b to application patterns 431-436. For example, software resources 441a-446b having a software resource type matching the software resource type of a particular application pattern 431-436 may be assigned to the particular application pattern 431-436.

Each application pattern 431-436 may be configured via a configuration environment executing on an enterprise computing device 312, for example. The configuration environment may include a set of user controls, presented on a user interface of the enterprise computing device 312, for selecting operating parameter values for a set of operating parameters defining the application pattern. For each operating parameter, the configuration environment may include a user control for entering an operating parameter value or for selecting an operating parameter value from a set of predetermined choices.

For example, when generating an application pattern, the configuration environment may include the following set of operating parameters for a user to select a corresponding value: a cloud service provider, a type of networking, access restrictions, a hosting service, an operating system, an ingestion service, a query processing service, a domain name system (DNS), a storage type, a configuration type, a patching protocol, a capacity, a level of data security, whether or not to include auto-scaling, a maintenance interval, a high availability (HA) service, an authentication service, a service level indicator (SLI), a recovery point objective (RPO), a recovery time objective (RTO), agents, etc.

In some implementations, a cloud development team may generate each of the layers 110, 120, 130 of the pattern-based cloud architecture 100 while an application developer may generate a pattern-based application which is implemented with the pattern-based cloud architecture 100. For example, a cloud development team may generate the base layer, the landing zone layer, and the application patterns 431 and 432. An application developer may generate the pattern-based applications 441a-442d which are implemented within the application patterns 431 and 432.

In other implementations, a cloud development team may generate some of the layers 110, 120, 130 of the pattern-based cloud architecture 100 while an application developer may generate other layers 110, 120, 130 of the pattern-based cloud architecture 100 and a pattern-based application which is implemented with the pattern-based cloud architecture 100. For example, a cloud development team may generate the base layer, and the landing zone layer. An application developer may generate the application patterns 433 and 434, and the pattern-based applications 443a-444 which are implemented within the application patterns 431 and 432.

In yet other implementations, a cloud development team may generate the base layer 110 of the pattern-based cloud architecture 100. An independent landing zone team may generate the landing zone and application pattern layers 120, 130 of the pattern-based cloud architecture 100, and an application developer may generate a pattern-based application which is implemented with the pattern-based cloud architecture 100. For example, a cloud development team may generate the base layer. An independent landing zone team may generate the landing zone layer and the application patterns 435 and 436. An application developer may generate the pattern-based applications 445-446b which are implemented within the application patterns 435 and 436.

In any event, when a developer creates or migrates a pattern-based application 441a assigned a particular application pattern 431, the enterprise computing device 312 deploys or runs the pattern-based application 441a in a live environment within the particular application pattern 431 and/or within a particular landing zone and base within in the cloud. The deployed pattern-based application 441a may then be provided to a wireless computing device 316 for display and/or execution at the wireless computing device 316.

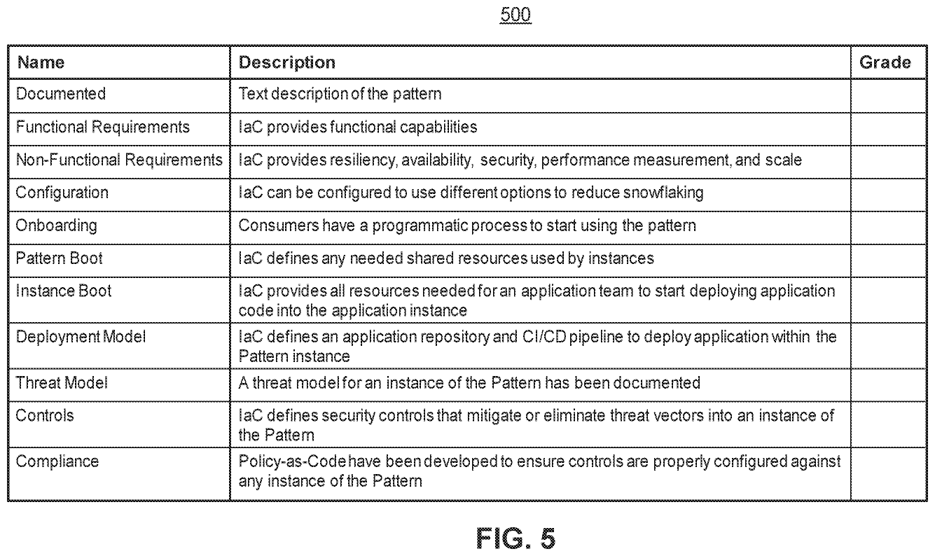

FIG. 5 illustrates an example data table 500 defining the operating parameters for application patterns in the pattern-based cloud system 200. The set of operating parameters may include a set of functional requirements operating parameters, a set of non-functional requirements operating parameters, a set of configuration operating parameters, a set of onboarding process operating parameters, a set of pattern boot process operating parameters, a set of instance boot process operating parameters, a set of deployment model operating parameters, a set of threat model operating parameters, a set of controls operating parameters, and a set of compliance rules operating parameters.

Functional requirements may include the infrastructure service used by an application instance, how data is stored and proceed, and how users or other applications access the application. The functional requirements may be implemented as IaC. Non-functional requirements may include how data is secured via a risk model and/or threat model, application performance metrics, such as SLIs, SLOs, and SLAs, how the application scales, and application failure protection metrics, such as an RPO and an RTO. The non-functional requirements may be implemented as IaC, SaC, TMaC, PiaC, etc. Configuration may include parameters of an instance of the application pattern. The onboarding process may include how to create a new instance of the pattern. The pattern boot process may include the one-time resources created and used by instances of the pattern and the instance boot process may include how to create a new instance of the pattern. The deployment model may include how application components are deployed within an instance of the pattern, and the threat model may include the threat vectors that exist on an instance of the pattern. The threat model may be implemented as TMaC. The controls may include security controls used to control threat vectors, such as access controls, encryption, threat prevention, etc. The controls may be implemented as SaC. The compliance rules may include rules to ensure that controls are configured correctly before and after application deployments of an instance of the pattern. The compliance rules may be implemented as PaC.

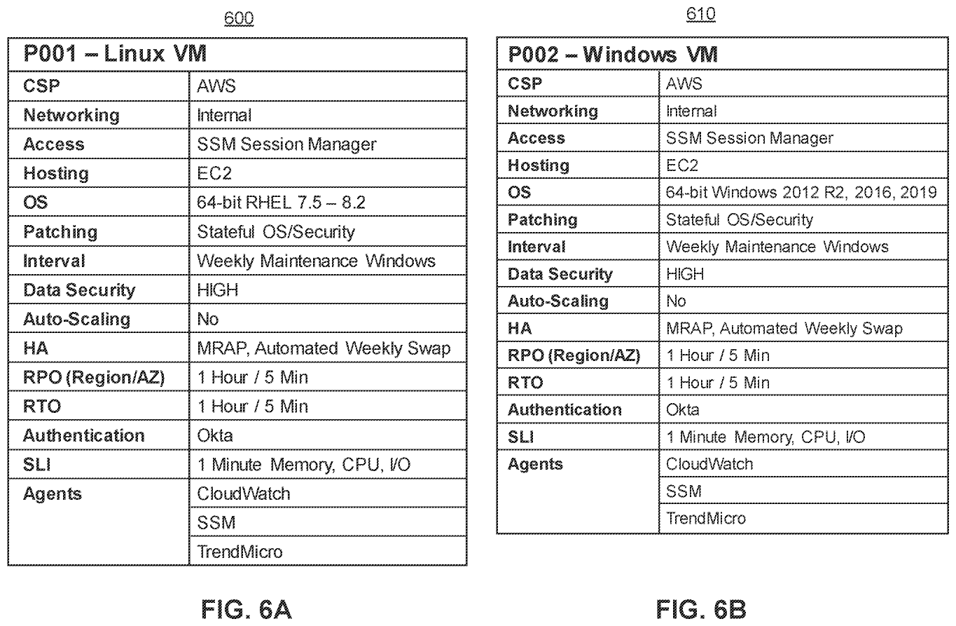

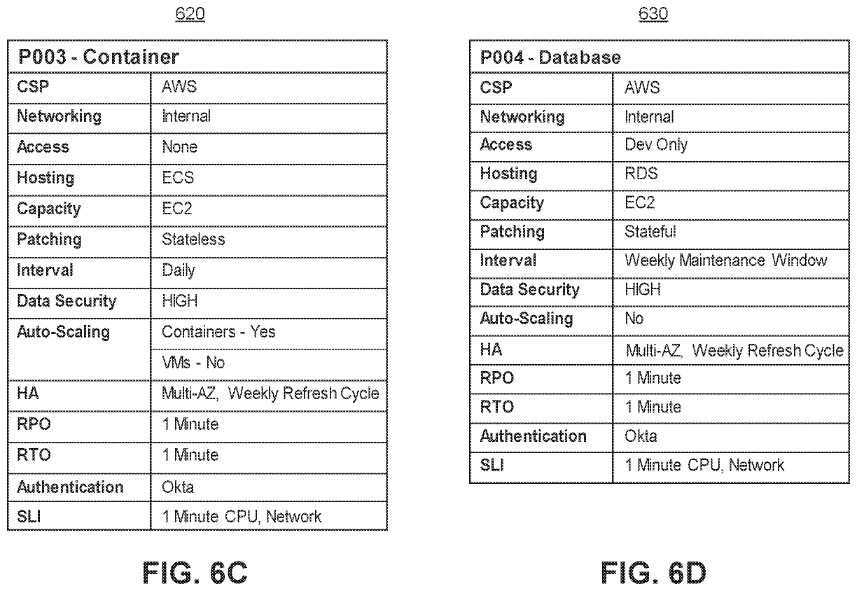

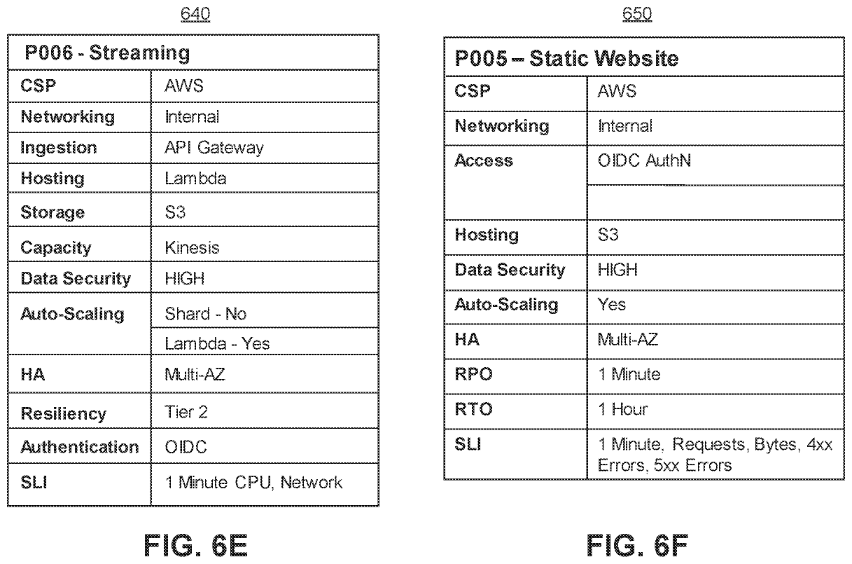

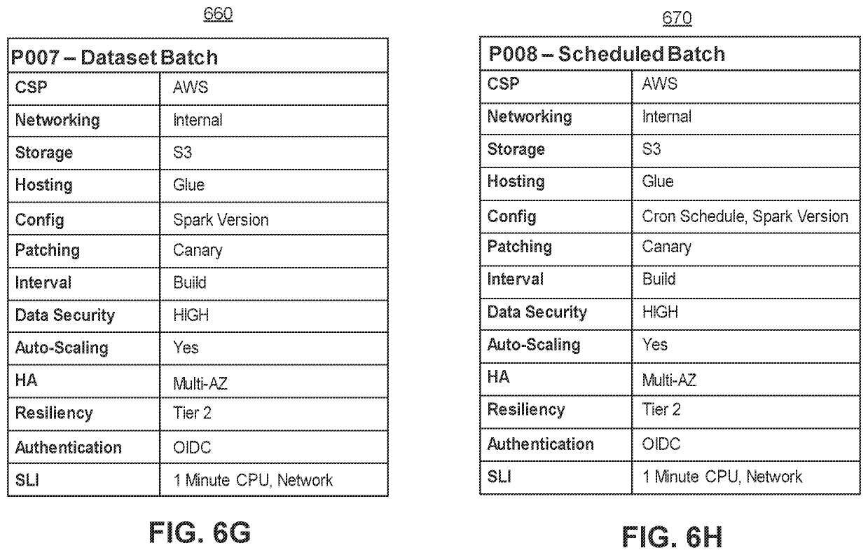

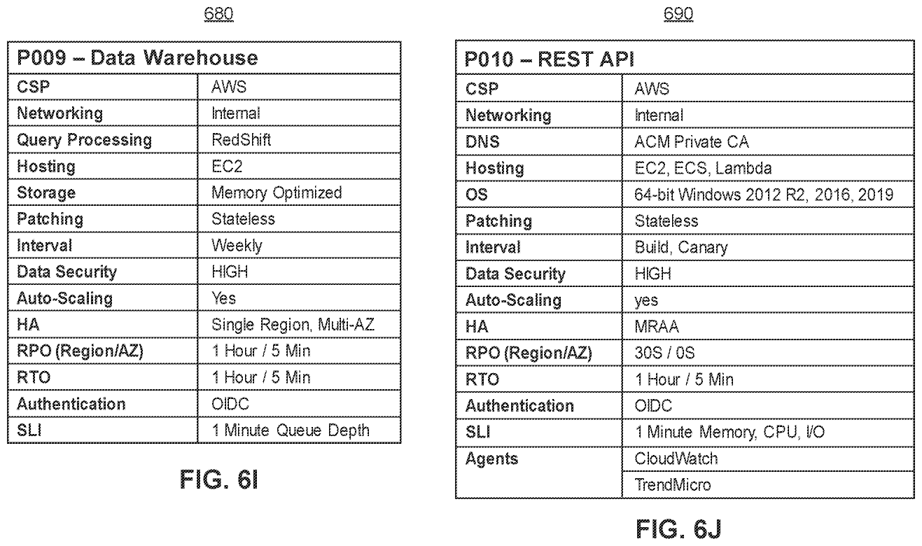

FIGS. 6A-6J illustrate example sets 600-690 of operating parameters and corresponding operating parameter values for different application patterns. Each application pattern may be generated for a particular software resource type. For example, the sets 600, 610 as shown in FIGS. 6A and 6B are for virtual machine application patterns, whereas the set 620 as shown in FIG. 6C is for a container application pattern. Each of the sets 600-690 may be presented on a user interface of an enterprise computing device 312 for a user to configure the application pattern for a particular software resource type. The user may view the configuration, may edit the operating parameter values in the configuration, may select landing zones to associate with the application pattern, and/or may save the updated configuration for the application pattern. The enterprise computing device 312 may then convert at least some portions of the updated configuration for the application pattern to IaC source code defined in a selected configuration language. According to one embodiment, the IaC source code is defined in HashiCorp Configuration Language (HCL) which is processed by the Terraform™ tool converting the HCL to cloud resources based on the IaC source code definition. According to another embodiment, the IaC source code is defined in a YAML configuration language which is processed by a tool converting the YAML definition to cloud resources based on the IaC source code definition. The enterprise computing device 312 may also convert at least some portions of the updated configuration for the application pattern to SaC source code. Moreover, the enterprise computing device 312 may convert at least some portions of the updated configuration to PaC source code, may convert at least some portions of the updated configuration to PiaC source code, and may convert at least some portions of the updated configuration to TMaC source code. The IaC source code, SaC source code, PaC source code, PiaC source code, and/or TMaC source code may then be used to run the pattern-based applications within the application pattern in a live environment operated in the cloud.

More specifically, as shown in FIG. 6A, the set 600 of operating parameters for a Linux virtual machine application pattern and corresponding operating parameter values include: a cloud service provider (AWS), a type of networking (Internal), access restrictions (SSM Session Manager), a hosting service (EC2), an operating system (64-bit RHEL 7.5-8.2), a patching protocol (Stateful OS/Security), a maintenance interval (Weekly Maintenance Windows), a level of data security (High), whether or not to include auto-scaling (No), an HA service (MRAP, Automated Weekly Swap), an RPO (1 Hour/5 Min), an RTO (1 Hour/5 Min), an authentication service (Okta), an SLI (1 Minute Memory, CPU, I/O), and agents (CloudWatch, SSM, TrendMicro). The operating parameter values for the Linux virtual machine application pattern may be selected via user controls in the configuration environment.

As shown in FIG. 6B, the set 610 of operating parameters for a Microsoft® virtual machine application pattern and corresponding operating parameter values include: a cloud service provider (AWS), a type of networking (Internal), access restrictions (SSM Session Manager), a hosting service (EC2), an operating system (64-bit Windows 2012 R2, 2016, 2019), a patching protocol (Stateful OS/Security), a maintenance interval (Weekly Maintenance Windows), a level of data security (High), whether or not to include auto-scaling (No), an HA service (MRAP, Automated Weekly Swap), an RPO (1 Hour/5 Min), an RTO (1 Hour/5 Min), an authentication service (Okta), an SLI (1 Minute Memory, CPU, I/O), and agents (CloudWatch, SSM, TrendMicro). The operating parameter values for the Microsoft® virtual machine application pattern may be selected via user controls in the configuration environment.

As shown in FIG. 6C, the set 620 of operating parameters for a container application pattern and corresponding operating parameter values include: a cloud service provider (AWS), a type of networking (Internal), access restrictions (None), a hosting service (ECS), a capacity (EC2), a patching protocol (Stateless), a maintenance interval (Daily), a level of data security (High), whether or not to include auto-scaling (Containers—Yes, Virtual Machines—No), an HA service (Multi-AZ, Weekly Refresh Cycle), an RPO (1 Min), an RTO (1 Min), an authentication service (Okta), and an SLI (1 Minute CPU, Network). The operating parameter values for the container application pattern may be selected via user controls in the configuration environment.

As shown in FIG. 6D, the set 630 of operating parameters for a database application pattern and corresponding operating parameter values include: a cloud service provider (AWS), a type of networking (Internal), access restrictions (Dev Only), a hosting service (RDS), a capacity (EC2), a patching protocol (Stateful), a maintenance interval (Weekly Maintenance Window), a level of data security (High), whether or not to include auto-scaling (No), an HA service (Multi-AZ, Weekly Refresh Cycle), an RPO (1 Min), an RTO (1 Min), an authentication service (Okta), and an SLI (1 Minute CPU, Network). The operating parameter values for the database application pattern may be selected via user controls in the configuration environment.

As shown in FIG. 6E, the set 640 of operating parameters for a streaming application pattern and corresponding operating parameter values include: a cloud service provider (AWS), a type of networking (Internal), an ingestion service (API Gateway), a hosting service (Lambda), a storage type (S3), a capacity (Kinesis), a level of data security (High), whether or not to include auto-scaling (Shard—No, Lambda—Yes), an HA service (Multi-AZ), a resiliency (Tier 2), an authentication service (OIDC), and an SLI (1 Minute Memory, CPU, I/O). The operating parameter values for the streaming application pattern may be selected via user controls in the configuration environment.

As shown in FIG. 6F, the set 650 of operating parameters for a static website application pattern and corresponding operating parameter values include: a cloud service provider (AWS), a type of networking (Internal), access restrictions (OIDC AuthN), a hosting service (S3), a level of data security (High), whether or not to include auto-scaling (Yes), an HA service (Multi-AZ), an RPO (1 Min), an RTO (1 Hour), and an SLI (1 Minute, Requests, Bytes, 4xx Errors, 5xx Errors). The operating parameter values for the static website application pattern may be selected via user controls in the configuration environment.

As shown in FIG. 6G, the set 660 of operating parameters for a dataset batch application pattern and corresponding operating parameter values include: a cloud service provider (AWS), a type of networking (Internal), access restrictions (S3), a hosting service (Glue), a configuration type (Spark Version), a patching protocol (Canary), a maintenance interval (Build), a level of data security (High), whether or not to include auto-scaling (Yes), an HA service (Multi-AZ), a resiliency (Tier 2), an authentication service (OIDC), and an SLI (1 Minute CPU, Network). The operating parameter values for the dataset batch application pattern may be selected via user controls in the configuration environment.

As shown in FIG. 6H, the set 670 of operating parameters for a scheduled batch application pattern and corresponding operating parameter values include: a cloud service provider (AWS), a type of networking (Internal), access restrictions (S3), a hosting service (Glue), a configuration type (Cron Schedule, Spark Version), a patching protocol (Canary), a maintenance interval (Build), a level of data security (High), whether or not to include auto-scaling (Yes), an HA service (Multi-AZ), a resiliency (Tier 2), an authentication service (OIDC), and an SLI (1 Minute CPU, Network). The operating parameter values for the scheduled batch application pattern may be selected via user controls in the configuration environment.

As shown in FIG. 6I, the set 680 of operating parameters for a data warehouse application pattern and corresponding operating parameter values include: a cloud service provider (AWS), a type of networking (Internal), a query processing service (Red Shift), a hosting service (EC2), a storage type (Memory Optimized), a patching protocol (Stateless), a maintenance interval (Weekly), a level of data security (High), whether or not to include auto-scaling (Yes), an HA service (Single Region, Multi-AZ), an RPO (1 Hour/5 Min), an RTO (1 Hour/5 Min), an authentication service (OIDC), and an SLI (1 Minute Queue Depth). The operating parameter values for the data warehouse application pattern may be selected via user controls in the configuration environment.

As shown in FIG. 6J, the set 690 of operating parameters for a REST API application pattern and corresponding operating parameter values include: a cloud service provider (AWS), a type of networking (Internal), a DNS (ACM Private CA), a hosting service (EC2, ECS, Lambda), an operating system (64-bit Windows 2012 R2, 2016, 2019), a patching protocol (Stateless), a maintenance interval (Build, Canary), a level of data security (High), whether or not to include auto-scaling (Yes), an HA service (MRAA), an RPO (30 s/0 s), an RTO (1 Hour/5 Min), an authentication service (OIDC), an SLI (1 Minute Memory, CPU, I/O), and agents (CloudWatch, TrendMicro). The operating parameter values for the REST API application pattern may be selected via user controls in the configuration environment.

In some implementations, deployment and management of the cloud computing environments may be partially automated through the use of infrastructure libraries defining the application patterns. In such embodiments, implementing the plurality of application patterns of the application pattern layer may comprise selecting and/or accessing one or more predefined infrastructure libraries, each predefined infrastructure library defining an application pattern. By using infrastructure libraries to define the application patterns, the time required for development and deployment of this pattern-based cloud architecture is reduced, while also ensuring a flexible approach to structuring the cloud environments. With this flexible structure, the development and deployment of pattern-based applications may be likewise improved.

Users may define application patterns via user controls in a configuration environment as shown in FIGS. 6A-6J. These application patterns may then be used to define infrastructure libraries which may be used to partially define the operating parameters for additional application patterns. Each infrastructure library includes one or more operating parameters, which may be included by reference to further data. After being defined, the infrastructure libraries may be stored for later use in designing and deploying application patterns. In some embodiments, the infrastructure libraries may be separate library files stored in one or more network-accessible data storage devices.

A user may select one or more previously defined infrastructure libraries to define an application pattern. The user may thus select a set of application pattern infrastructure libraries via a user interface of a computing device, such as by adding the library files to a batch file, by providing input to a cloud architecture management application, or by other means. In some embodiments, a selection software interface or application (e.g., a configuration application running on local or cloud hardware) may validate the one or more selected application pattern infrastructure libraries for conflicts between operating parameters or services. Such a selection software interface or application may further verify any required categories of operating parameters or services have been indirectly selected through selection of application pattern infrastructure libraries defining such elements of the base. Additionally or alternatively, some embodiments may include the selection of one or more default infrastructure libraries defining default operating parameters and services to be used unless preempted by other selected application pattern infrastructure libraries.

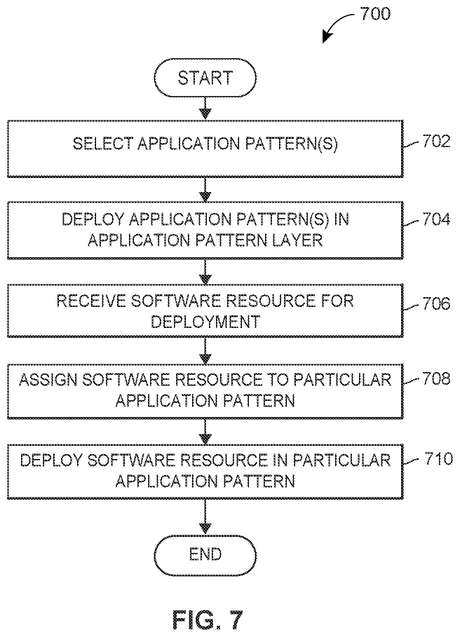

FIG. 7 illustrates an example method 700 for deploying software resources in a cloud service according to an application pattern, which can be implemented at a computing device. The method can be implemented in a set of instructions stored on a computer-readable memory and executable at one or more processors of the computing device.

At block 702, an application pattern layer is selected. The application pattern may include a set of operating parameters defining aspects of a cloud computing environment. The set of operating parameters may be implemented as IaC, SaC, PaC, TMaC, PiaC, etc. The set of operating parameters may include a set of functional requirements operating parameters, a set of non-functional requirements operating parameters, a set of onboarding process operating parameters, a set of pattern boot process operating parameters, a set of instance boot process operating parameters, a set of deployment model operating parameters, a set of threat model operating parameters, a set of controls operating parameters, a set of compliance rules operating parameters, or any suitable combination of these.

A user, such as a member of a cloud development team, may define the application pattern by selecting operating parameter values via user controls. In other implementations, the user may select previously defined application pattern infrastructure libraries to define an application pattern.

At block 704, the selected application pattern 131 is deployed within an application pattern layer 130 in a cloud service. The application pattern layer 130 includes application pattern(s) 131-138 for type(s) of software resource(s).

At block 706, the enterprise computing device 312 receives a software resource for deployment, such as a pattern-based application and determines the type of software resource. Then the enterprise computing device 312 assigns the software resource to a particular application pattern 131 in the application pattern layer 130 (block 708).

In some implementations, the enterprise computing device 312 may assign the software resource to a particular application pattern 131 when the type of software resource matches the software resource type of the particular application pattern 131. Also in some implementations, the enterprise computing device 312 may assign the software resource to a particular application pattern 131 when the operating system for the software resource matches the operating system of the particular application pattern 131.

Then the enterprise computing device 312 runs or deploys the software resource within the particular application pattern 131 to a live environment in the cloud service (block 710). The live environment may include the particular application pattern 131 from the application pattern layer 130, a landing zone 122-1a corresponding to the particular application pattern 131 from a landing zone layer 130, and a corresponding base 112-1 from a base layer 110.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for standardizing requirements for deploying software resources in a cloud service according to an application pattern through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for deploying software resources in a cloud service according to an application pattern, the method comprising:
implementing, by one or more processors, an application pattern layer comprising one or more application patterns for one or more types of software resources deployed in a cloud service, each application pattern including a set of operating parameters defining aspects of a cloud computing environment;
obtaining, by the one or more processors, a particular software resource for deployment in the cloud service;
assigning, by the one or more processors, the particular software resource to a particular one of the one or more application patterns; and
running, by the one or more processors, the particular software resource within the particular application pattern in the cloud service.

2. The method of claim 1, wherein the set of operating parameters for each application pattern includes one or more of: a set of functional requirements operating parameters, a set of non-functional requirements operating parameters, a set of onboarding process operating parameters, a set of pattern boot process operating parameters, a set of instance boot process operating parameters, a set of deployment model operating parameters, a set of threat model operating parameters, a set of controls operating parameters, or a set of compliance rules operating parameters.

3. The method of claim 2, wherein the operating parameters in the set of operating parameters for the particular application pattern are implemented using one or more of: Infrastructure-as-Code (IaC), Policy-as-Code (PaC), Security-as-Code (SaC), Pipeline-as-Code (PiaC), or Threat-Modeling-as-Code (TMaC).

4. The method of claim 1, wherein each application pattern implements for all instances of the application pattern at least one of: security, compliance, configuration, onboarding, deployment, authentication, authorization, resiliency, performance, or data access.

5. The method of claim 1, wherein the software resource type is at least one of: a report, an approval workflow, an Internet of Things (IoT) device service, a web application, a container, a container cluster, a 3-tier web application, and ETL transformation, an ELT transformation, a virtual machine, a user desktop, a website, a database, a data warehouse, a streaming service, a batch service, or an application programming interface (API).

6. The method of claim 1, further comprising:
implementing, by the one or more processors, a landing zone layer comprising a plurality of landing zones, wherein each landing zone comprises a cloud computing environment configured with a plurality of operating parameters defining aspects of the cloud computing environment in running cloud-based software applications,
wherein implementing the application pattern layer includes implementing one or more application patterns for one or more of the plurality of landing zones.

7. The method of claim 6, wherein the particular application pattern is implemented in one landing zone provided by one cloud service provider.

8. The method of claim 6, wherein the particular application pattern is implemented in a plurality of landing zones provided by a plurality of cloud service providers.

9. The method of claim 6, further comprising:
implementing, by the one or more processors, a base layer comprising one or more bases, wherein each base provides a plurality of base services for network communication and for cloud environment management,
wherein implementing the landing zone layer includes implementing one or more landing zones for each of the one or more bases.

10. The method of claim 1, further comprising:
assigning, by the one or more processors, the particular software resource to the particular application pattern in response to determining that the particular software resource has a software resource type matching the software resource type for the particular application pattern.

11. A computing device for deploying software resources in a cloud service according to an application pattern, the computing device comprising:
one or more processors; and
a non-transitory computer-readable memory coupled to the one or more processors and storing instructions thereon that, when executed by the one or more processors, cause the computing device to:
implement an application pattern layer comprising one or more application patterns for one or more types of software resources deployed in a cloud service, each application pattern including a set of operating parameters defining aspects of a cloud computing environment;
obtain a particular software resource for deployment in the cloud service;
assign the particular software resource to a particular one of the one or more application patterns; and
run the particular software resource within the particular application pattern in the cloud service.

12. The computing device of claim 11, wherein the set of operating parameters for each application pattern includes one or more of: a set of functional requirements operating parameters, a set of non-functional requirements operating parameters, a set of onboarding process operating parameters, a set of pattern boot process operating parameters, a set of instance boot process operating parameters, a set of deployment model operating parameters, a set of threat model operating parameters, a set of controls operating parameters, or a set of compliance rules operating parameters.

13. The computing device of claim 12, wherein the operating parameters in the set of operating parameters for the particular application pattern are implemented using one or more of: Infrastructure-as-Code (IaC), Policy-as-Code (PaC), Security-as-Code (SaC), Pipeline-as-Code (PiaC), or Threat-Modeling-as-Code (TMaC).

14. The computing device of claim 11, wherein each application pattern implements for all instances of the application pattern at least one of: security, compliance, configuration, onboarding, deployment, authentication, authorization, resiliency, performance, or data access.

15. The computing device of claim 11, wherein the software resource type is at least one of: a report, an approval workflow, an Internet of Things (IoT) device service, a web application, a container, a container cluster, a 3-tier web application, and ETL transformation, an ELT transformation, a virtual machine, a user desktop a website, a database, a data warehouse, a streaming service, a batch service, or an application programming interface (API).

16. The computing device of claim 11, wherein the instructions further cause the computing device to:
implement a landing zone layer comprising a plurality of landing zones, wherein each landing zone comprises a cloud computing environment configured with a plurality of operating parameters defining aspects of the cloud computing environment in running cloud-based software applications,
wherein the application pattern layer includes one or more application patterns for one or more of the plurality of landing zones.

17. The computing device of claim 16, wherein the particular application pattern is implemented in one landing zone provided by one cloud service provider.

18. The computing device of claim 16, wherein the particular application pattern is implemented in a plurality of landing zones provided by a plurality of cloud service providers.

19. A non-transitory computer-readable memory coupled to the one or more processors and storing instructions thereon that, when executed by the one or more processors, cause the one or more processors to:
implement an application pattern layer comprising one or more application patterns for one or more types of software resources deployed in a cloud service, each application pattern including a set of operating parameters defining aspects of a cloud computing environment;
obtain a particular software resource for deployment in the cloud service;
assign the particular software resource to a particular one of the one or more application patterns; and
run the particular software resource within the particular application pattern in the cloud service.

20. The non-transitory computer-readable memory of claim 19, wherein the set of operating parameters for each application pattern includes one or more of: a set of functional requirements operating parameters, a set of non-functional requirements operating parameters, a set of onboarding process operating parameters, a set of pattern boot process operating parameters, a set of instance boot process operating parameters, a set of deployment model operating parameters, a set of threat model operating parameters, a set of controls operating parameters, or a set of compliance rules operating parameters.
